(19) United States
(12) Patent Application Publication
(10) Pub. No.: US 2008/0269933 A1
(43) Pub. Date: Oct. 30, 2008

(54) METHOD FOR SURFACE-BASED MACHINING OF DECORATIVE ARTICLES

(76) Inventor: Wesley V. Barbir, Phoenix, AZ (US)

Correspondence Address: STETINA BRUNDA GARRED & BRUCKER, 75 ENTERPRISE, SUITE 250, ALISO VIEJO, CA, 92656, US

(21) Appl. No.: 12/058,246

(22) Filed: Mar. 28, 2008

Related U.S. Application Data
(60) Provisional application No. 60/921,548, filed on Apr. 3, 2007.

(51) Int. Cl. G05B 19/19; G06F 19/00

(52) U.S. Cl. 700/98

(57) ABSTRACT

A method for surface-based machining of a decorative article is provided. The method includes retrieving a first graphical representation of the decorative article, and deriving a surface representation therefrom. The surface representation may have one or more segments. The method also includes deriving a tool path for each of the segments of the surface representation. By machining a workpiece in accordance with the tool paths, the decorative article is produced.

### CROSS-REFERENCE TO RELATED APPLICATIONS

This application relates to and claims the benefit of U.S. Provisional Application No. 60/921,548 filed Apr. 3, 2007 and entitled METHOD FOR SURFACE-BASED MACHINING OF DECORATIVE ARTICLES which is wholly incorporated by reference herein.

### FEDERALLY SPONSORED RESEARCH/DEVELOPMENT

Not Applicable

### BACKGROUND

1. Technical Field

The present invention generally relates to decorative carving methods. More particularly, the present invention relates to methods for surface-based machining of decorative articles that utilize Computer Numerical Control (CNC) equipment.

2. Related Art

Contemporary architecture and interior design practices frequently call for fine decorative articles such as carvings and moldings to accent homes, offices, and other architectural spaces. Such decorative accessories may be found in arches, keys, crowns, cabinet parts, capitals, columns, corbels, mantels, moldings, onlays, pulls, and various other panels and products. The accessories often incorporate elegant and artistic designs such as flowers, vines, leaves, shrubs, medallions, and the like. Various types of materials, such as woods including maple, red oak, cherry, white oak, mahogany, black walnut, and alder woods are utilized. Other materials may include fiberboard, plastic, and composites, which are especially useful when it is not desirable for the final product to show any wood grain, or when the final product will be painted instead of being stained.

These accessories may be incorporated in to doors, cabinets, houses, and other structures as desired to provide ornamental designs and decorative appearances, thus enhancing the aesthetic appeal of the area in which such ornamental architectural elements are found. Traditionally, and for much of the past, these accessories have been hand-carved using chisels, gouges, mallets, and other well-known manual tools. More recently, however, techniques have been developed to automate the carving process.

Automated carving techniques typically utilize Computer Numerical Control (CNC) machines. CNC machines include a computer controller that directs the operations of machine tools, which are the operative components that perform the carving. For example, the machine tools may be tool bits that cut, drill, route, or otherwise remove material from a work piece. In turn, the machine tools are connected to a motive force such as an electrical or pneumatic motor that is under the control of the computer controller. The computer controller is provided with programming that sequences the movement of the machine tool along the work piece as well as the cutting/drilling/routing operations.

The programming is typically provided as G-code, which can be produced by various Computer Aided Manufacturing (CAM) software packages. G-code includes instructions that represent linear movement as well as circular or arcuate movement of the machine tool. Additional instructions relating to machining speeds, orientation of the work piece, and selection of tool bits may also be included in the G-code instructions. Where a contour cannot be represented by basic linear and arcuate segments, series of short lines or curves that approximate such a contour are substituted. Typically, the G-code generated by the CAM software is parsed by a post-processor that optimizes it for a particular CNC machine. CNC machines have significantly improved quality and consistency in the finished product, and so are particularly suited for the mass-production of such products.

Due to the complexity of the machining instructions necessary to create the decorative articles, the designer typically does not program the G-code instructions directly, and instead, develops the design electronically in a graphical environment of a Computer Aided Design (CAD) software application. Various software packages are utilized to model the envisioned product in a three-dimensional space. Upon completing the design, G-code instructions corresponding to the model may be exported and executed on the CNC machine.

Intermediate to the visual representation in the graphical environment and the CNC G-code instructions, the model of the accessory may be stored and represented as a solid, a series of surfaces, or a collection of points along a Cartesian coordinate space. Most commonly, the article is stored in a Stereolithography Tessalation Language (STL) file, which represents a three dimensional structure as a closed body arrangement of triangular facets or patches. Each patch is defined with three points and an orientation vector. In converting the solid or surface model to the triangular facet model, a predefined tolerance is applied by a fitting algorithm to ensure that the final representation is completely closed.

Though there are advantages to working with STL files and the triangular facet form during machining processes, there are also a number of significant disadvantages. The most apparent is that a faceted model is only an approximation of the original surface geometry. As such, the accuracy of the completed article may be less than satisfactory, which is particularly problematic in the intricate designs contemplated for the aforementioned decorative accessories. Although faceting tolerances may be substantially tightened, the completed article may have jagged edges and surfaces that necessitate post-machining processing such as sanding and/or planing. It will also be appreciated that a large number of triangles (and corresponding vertex coordinates) are necessary to represent complex structures, resulting in large STL file sizes and increased processing time. Additionally, editing the STL file after creation is difficult. Any changes to the design of the accessory must be made through the CAD software, which may or may not be available in the proximity of the CNC machine. Thus, it is necessary that the CAD software generate consistent and properly closed models. Along these lines, STL files generally do not scale easily, as the individual vertices of the composite triangles will become more visible as the size of the overall model is increased. In order to produce similarly configured decorative accessories in multiple sizes, it is necessary to produce multiple STL files for each size, leading to additional file management complexities.

Therefore, there is a need in the art for an automated decorative carving method that decreases the processing time and improves the quality and consistency of the machined article. More particularly, there is a need for a decorative carving method that minimizes post-machining processing. Further, there is a need in the art for a method for producing decorative carvings of multiple scales and configurations based upon a single three-dimensional model.

### BRIEF SUMMARY

In accordance with one aspect of the present invention, there is provided a method for surface-based machining of a decorative article. The method may include retrieving a first graphical representation of the decorative article. Additionally, the method may include deriving a surface representation of the decorative article from the first graphical representation. The surface representation may have one or more segments. The method may also include deriving a tool path for each of the segments of the surface representation, and generating machine instructions to a computer numerical control machine that correspond to the tool paths. The decorative article may be obtained by machining a workpiece in accordance with the tool paths. The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a flowchart illustrating the steps of a method for surface based machining of decorative articles in accordance with one embodiment of the present invention; and

FIG. 2 is a perspective view of an exemplary decorative article shown as a collection of surface segments.

FIG. 3 is a diagram of an exemplary computer system;

FIG. 4 is an illustration of a laser scanning device scanning a decorative article in accordance with one embodiment of the present invention;

FIG. 5 is a graphical representation of a point cloud generated by the laser scanning device; and

FIG. 6 is an exemplary illustration of a point cloud and a corresponding surface representation.

Common reference numerals are used throughout the drawings and the detailed description to indicate the same elements.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions of the invention in connection with the illustrated embodiment. It is to be understood, however, that the same or equivalent functions and may be accomplished by different embodiments that are also intended to be encompassed within the scope of the invention. It is further understood that the use of relational terms such as first and second, top and bottom, and the like are used solely to distinguish one from another entity without necessarily requiring or implying any actual such relationship or order between such entities.

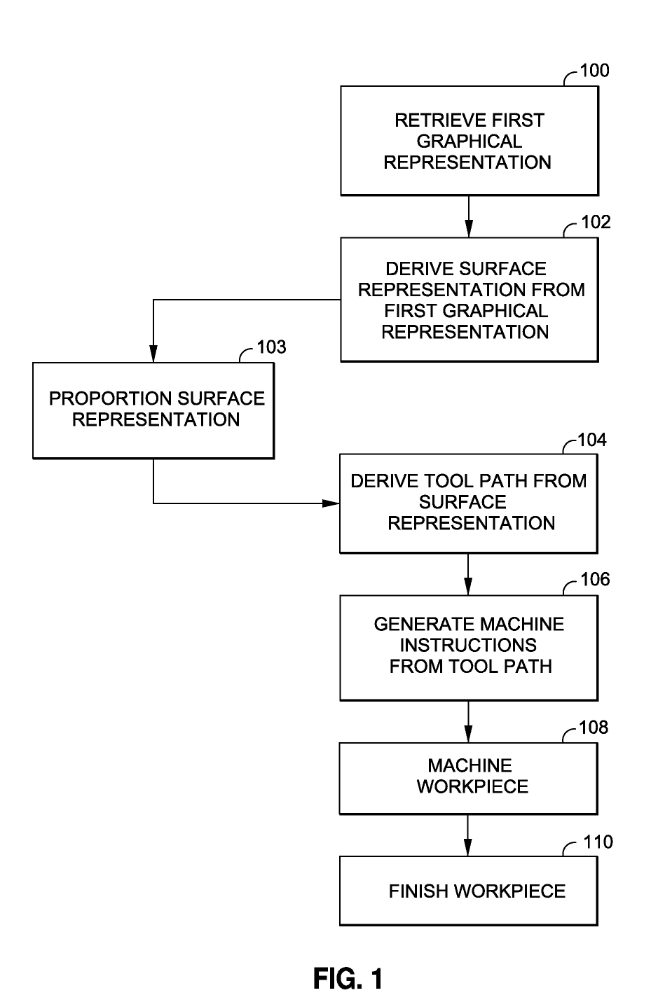

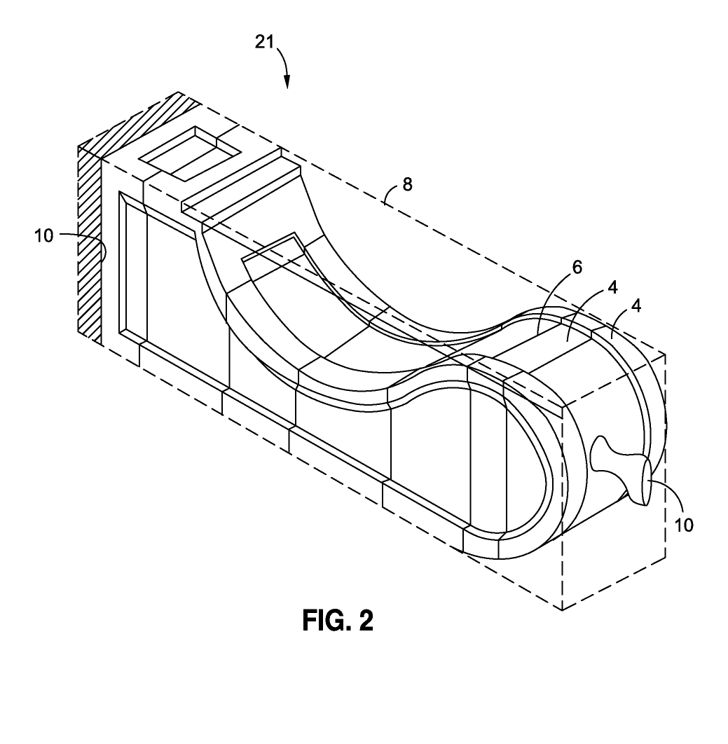

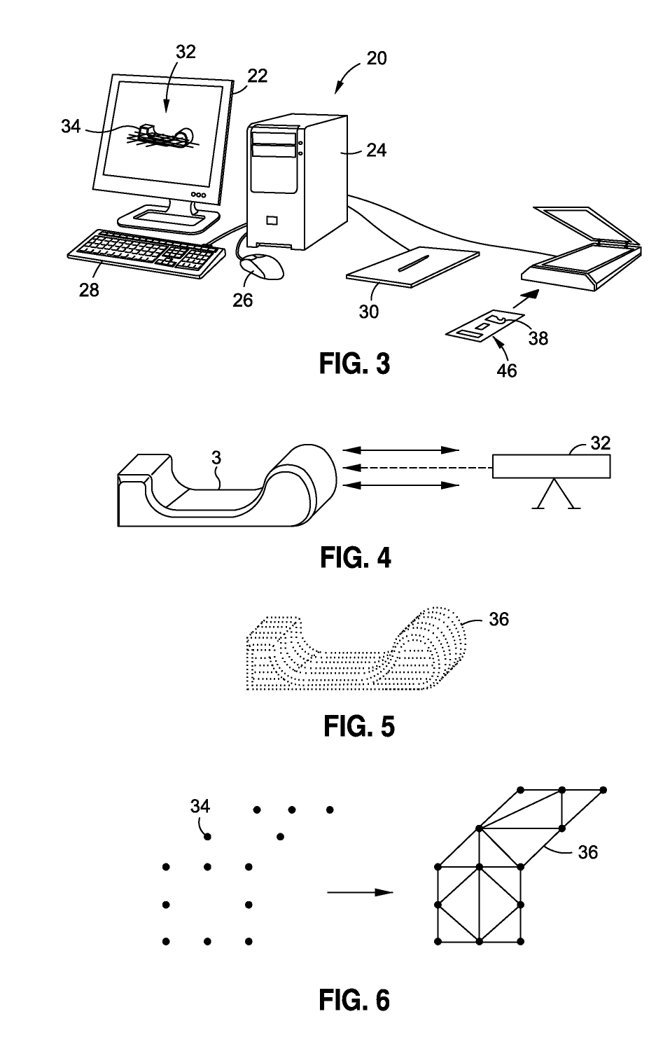

With reference to the flowchart of FIG. 1 and an exemplary carving as shown in FIG. 2, a method in accordance with one aspect of the present invention begins with a step 100 of retrieving a first graphical representation of the decorative article 2 or corbel. The first graphical representation may be a three dimensional model or a line drawing of the decorative article 2, though any other suitable form may be readily substituted without departing from the scope of the present invention. Generally, the process of retrieving the first graphical representation refers to generating on a computer workstation 20, illustrated in FIG. 3, one or more depictions of the decorative article 2 as contemplated by a designer.

As indicated briefly in the background above, a three-dimensional model 34 of the decorative article 2 as shown in FIG. 3 may be created on the computer workstation 20 according to a variety of well known techniques. By way of example only and not of limitation, the computer workstation 20 may include a monitor or display 22, which graphically displays data produced by the computer 24. The computer 24 is understood to respond to inputs provided via a mouse 26, a keyboard 28, and a graphics tablet 30. A CAD operator may “draw” line segments, arcs, and other components using the display 22 and the mouse 26 or the tablet 30.

As shown in FIG. 4, where a pre-existing physical embodiment 3 of the decorative article is available, the preferred method is scanning it, as opposed to the more time-consuming task of preparing a model 34 directly on the computer workstation 20. In scanning the physical embodiment 3 of the decorative article 2, a laser scanner 32 may sweep the surface thereof. The flight time of the laser pulse may be utilized to determine the distance delta from the laser scanner 32 to each point on the decorative article 2 that reflects the laser. Upon scanning, a point cloud 36 of three-dimensional points that represent the physical boundaries of the decorative article 2 is produced by the computer workstation 20. Prior to the scan, a descriptor of the decorative article 2, the size thereof, and the positioning of the scanner 32 may be defined and entered into the computer workstation 20. In certain circumstances, it may be beneficial to coat the surface of the decorative article 2 with a dulling material to improve laser scanning accuracy.

After obtaining the point cloud 36, the model represented thereby is manipulated for improved efficiency in transforming it to a solid model. As utilized herein, the term solid model refers to an electronic representation of a physical object based upon its volumetric properties. Among the more common processing operations include smoothing the transition between data points and eliminating extraneous data points through noise reduction. As will be appreciated by one of ordinary skill in the art, a variety of noise reduction techniques exist, such as the application of Gaussian filters on the point cloud data. In this technique, a mask comprised of a Gaussian function is convolved with the point cloud 34. This results in individual point cloud data points that are closer in value to its neighbors. As will be further appreciated, however, Gaussian filter noise reduction techniques may blur legitimate edges on the point cloud 34. Alternatively, non-linear filters such as median filters may be applied to the point cloud 34, whereby each point is compared to neighboring points to determine the intensity thereof. Median values are determined based upon a comparison to such neighboring points, and the particular point under analysis is re-adjusted to the median value. It is understood that this noise reduction technique is useful for eliminating “salt and pepper noise” from image data, without compromising the appearance of edges with blurring.

With reference to FIG. 6, the point cloud 34 may then be transformed into a polygonal mesh 36. The polygonal mesh 36 is a set of polygons such as triangles, quadrilaterals, and/or vertices that define a three-dimensional object, and is generated by a triangulation process. The polygonal mesh model is edited to fill any holes therein where there is insufficient data for accurate representation. Boundaries are also verified and repaired for generating a continuous, uninterrupted surface, and the number of control points may be adjusted to smooth the outline of the polygonal mesh 36. The polygonal mesh 36 may be stored in a stereolithography tessellation (STL) file, which as described above, represents a solid object with triangular patches or facets.

As indicated above, the first representation of the decorative article 2 may also be in the form of a line drawing 38. In further detail, line drawings refer to graphical representations of objects in which the boundaries thereof are defined by lines and arcs. By way of example shown in FIG. 3, a picture 40 or sketch of the decorative article 2 may be digitized via a scanner 42, also connected to the computer workstation 20, and stored as a two-dimensional image thereon. From the image, various lines and arcs corresponding to the boundaries of the decorative article in the two-dimensional digitized form may be generated.

Referring back to FIG. 1, the method further includes a step 102 of deriving a surface representation from the first graphical representation of the decorative article 2. As best illustrated in FIG. 2, such a surface representation defines the decorative article 2 as a plurality of surface segments 4. In accordance with one embodiment of the present invention, the surface representation may be a Non-Uniform Rational B-Spline (NURBS) surface. Where a polygonal mesh was generated after obtaining a point cloud of scan points of a physical model of the decorative article 2, surface patches are uniformly arranged in a layout representative of the shape of the decorative article. A NURBS surface is fit to each patch, while retaining tangent continuity across all patch boundaries. This involves defining the various curvatures of the decorative article 2, in which a contour line is determined by the number of curvature changes. The model is separated into regions of high curvature and low curvature changes, and contour lines are defined. The NURBS surface is then divided into quadrangular patches or the segments 4. Each of the segments 4 are connected to each other by boundary lines or curves 6, and as indicated above, arranged to cover the entire surface of the decorative article 2. The NURBS surface representing the entirety of the decorative article 2 may be open or closed, and essentially wrap around the features of the decorative article 2. The resulting surface representation may be exported as an IGES (Initial Graphics Exchange Specification) file, a vendor-neutral data format.

Alternatively, the surface representation may be derived from a first representation of the decorative article 2 that is a line drawing. In this regard, surface modeling CAD applications, as opposed to solid modeling mentioned above, may be utilized. By way of example only and not of limitation, the CATIA Product Lifecycle Management application from Dassault Systemes of Suresnes, France may be utilized to generate the surface representation. As understood, the CATIA application defines various surfaces in accordance with NURBS. Therefore, upon creating the surface representation is comprised of a series of the segments 4 with bordering lines or curves 6. The surface representation is also stored in an IGES file.

With reference again to the flowchart of FIG. 1, according to step 103, the method may continue with proportioning or scaling the surface representation of the decorative article 2. As indicated above, it is often desirable to construct a similarly shaped decorative article at various sizes to accommodate different uses while maintaining a consistent architectural theme. It will be appreciated that the surface representation may be scaled without introducing tooling lines or jagged machining marks on the completed decorative article 2, resulting in less post-machining processing.

Still referring to the flowchart of FIG. 1, the method continues with a step 104 of deriving a tool path from the surface representation generated in step 102 and properly scaled in step 103. More particularly, G-code representative of the decorative article 2 is generated according to step 106. As described above, G-codes are instructions that represent movements of the machine tools, and are processed by the CNC machine. It is understood that although a standard for the G-code language exists, the specific code used to control a particular CNC machine may vary widely. Thus, as utilized herein, G-code refers generally to any set of programming instructions that direct the operation of CNC machines.

NURBS is understood to define points along the various contours such that a CNC machine can interpolate the arcs along the path created defined by the NURBS surface, resulting in high machining accuracy and an improved surface finish. Greater management of the toolpath is possible because of its representation as a NURBS surface, and improvements of up to 25% in speed and machining quality over existing carving techniques are possible. Various software applications are known in the art that converts a surface file to tool paths, including PowerMill and ArtCAM from Delcam of Birmingham, UK.

With reference to FIG. 2, the decorative article 2 is a solid rectangular block or workpiece having an outline 8 as shown prior to machining. Additionally, the decorative article 2 may include one or more support members 10 extending therefrom. It is understood that the support members 10 are not defined as part of the decorative article, and used by the CNC machine to hold the workpiece in place during machining. As such, the support members 10 remain unmachined.

As shown in the flowchart of FIG. 1, the method in accordance with an aspect of the present invention may include machining the workpiece 108 using the CNC machine based upon the generated machine instructions to produce the decorative article 2. Upon completing the machining, the decorative article 2 may be sanded and smoothed, and various surface treatments such as stains, varnishes, sealants, and paint may be applied. Such post-machining processes, as well as other like frequently used processes, are generally referred to as finishing step 110. However, it is anticipated that due to the high accuracy of the machining resulting from generating the tool paths from the surface representations, such post-machining processing, in particular, sanding and smoothing, will be limited.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A method for surface-based machining of a decorative article, the method comprising:
retrieving a first graphical representation of the decorative article;
deriving a surface representation of the decorative article from the first graphical representation, the surface representation having one or more adjacent segments;
deriving a tool path for each of the segments of the surface representation; and
generating machine instructions to a computer numerical control machine, the machine instructions corresponding to the derived tool paths.

2. The method of claim 1, wherein the workpiece defines at least one support member extending therefrom.

3. The method of claim 1, wherein retrieving a first graphical representation includes:
scanning a physical embodiment of the decorative article;
generating a point cloud representative of boundary points of the decorative article; and
converting the point cloud into the first graphical representation.

4. The method of claim 1, wherein retrieving a first graphical representation includes:
receiving a three-dimensional volumetric representation of the decorative article; and
converting the volumetric representation into the first graphical representation.

5. The method of claim 1, wherein retrieving a first graphical representation includes:
receiving a two-dimensional line drawing representative of the decorative article; and
converting the line drawing into the first graphical representation.

6. The method of claim 1, wherein the first graphical representation of the decorative carving is contained in a stereolithography tessellation file, the method further including:
converting the stereolithography tessellation file to a surface representation.

7. The method of claim 1, wherein the surface representation is a non-uniform rational B-spline (NURBS) surface.

8. The method of claim 7, wherein the NURBS surface data is stored in an interchangeable data format.

9. The method of claim 1, wherein prior to deriving the tool path, the method further includes:
adjusting the scale of the surface representation of the decorative article according to a predefined ratio.

10. The method of claim 1, wherein the tool path is defined in a G-code file.

11. The method of claim 1, further comprising:
machining a workpiece based upon the tool paths represented by the machine instructions to produce the decorative article.

12. The method of claim 11, further comprising:
finishing the decorative article.

13. A computer-readable medium having computer-executable instructions for performing a method comprising:
retrieving a first graphical representation of the decorative article;
deriving a surface representation of the decorative article from the first graphical representation, the surface representation having one or more adjacent segments;
deriving a tool path for each of the segments of the surface representation; and
generating machine instructions to a computer numerical control machine, the machine instructions corresponding to the derived tool paths.
